(19) United States
(12) Patent Application Publication
(10) Pub. No.: US 2006/0230769 A1
(43) Pub. Date: Oct. 19, 2006

(54) Superconducting magnet device-monitoring system, method of monitoring superconducting magnet device and MRI device

(75) Inventor: Kazuto Nogami, Nasushiobara-Shi (JP)

Correspondence Address: NIXON & VANDERHYE, PC, 901 NORTH GLEBE ROAD, 11TH FLOOR, ARLINGTON, VA, 22203, US

(73) Assignees: KABUSHIKI KAISHA TOSHIBA, Tokyo (JP); TOSHIBA MEDICAL SYSTEMS CORPORATION, Otawara-Shi (JP)

(21) Appl. No.: 11/324,328

(22) Filed: Jan. 4, 2006

(30) Foreign Application Priority Data
Jan. 11, 2005 (JP) P2005-3471

(51) Int. Cl. G01K 13/00; G01M 1/38; G01V 3/00

(52) U.S. Cl. 62/129; 700/275; 324/318

(57) ABSTRACT

A superconducting magnet device-monitoring system includes detecting unit, remaining amount estimating unit, and output unit. The detecting unit detects a remaining amount of liquid helium, in which a superconducting coil is immersed stored in a liquid helium container of a superconducting magnet device. The remaining amount estimating unit calculates an estimated remaining amount, which shows an estimated value of the remaining amount, on the basis of the remaining amount of liquid helium preliminarily detected by the detecting unit. The output unit outputs monitoring information on the superconducting magnet device on the basis of the detected remaining amount and estimated remaining amount of liquid helium.

### BACKGROUND OF THE INVENTION

1. Field of the Invention

The present invention relates to a superconducting magnet device-monitoring system that monitors a liquid helium immersion cooling-type superconducting magnet, a method of monitoring a superconducting magnet device and an MRI device.

2. Description of the Related Art

In recent years, various devices adopting a liquid helium immersion cooling-type superconducting magnet such as magnetic resonance imaging (MRI) system or the like are widely used. This type of superconducting magnet includes a container storing extremely low-temperature liquid helium (liquid helium container) and cools a substance by immersing a superconducting coil in the liquid helium container so as to generate a superconducting state (for example, see JP-A-2001-143922).

In general, a manometer that measures an internal pressure of the liquid helium container or a liquid-level meter (also called level sensor, probe or the like) that measures a remaining amount of liquid helium is used to monitor a state of liquid helium in the container. As the manometer, mechanical manometer, electronic pressure transducer or the like is adopted (for example, see JP-A-2003-69092).

In addition, what is adopted as the liquid-level meter is as follows: A device includes a composite wire of superconductor and normal conductor, which is disposed to cross the surface of liquid helium. The device heats the composite wire and then measures the resistance. After that, the measured resistance is converted into a length ratio of portion of the composite wire immersed in the liquid helium (portion of the superconductor in a superconducting state) to portion of the composite wire not immersed in the liquid helium (portion of the superconductor in a normal conducting state) so as to extrude the liquid level of the liquid helium (remaining amount) (for example, see JP-A-6-307914).

The above manometer or liquid-level meter is generally provided at a service port (also called service turret) of the liquid helium container. The service port is used when a current lead is mounted on a superconducting coil in the liquid helium container, liquid helium is replenished into the container or gaseous helium is discharged from the container to the outside (see JP-A-7-183116).

FIG. 12 shows the rough structure of the liquid helium container in the related art. The liquid helium container 1000 shown in FIG. 12 includes a container main body 1001 and a service port 1100. The container main body 1001 has a double wall structure, which forms a vacuum layer to reduce heat transmission through the container. A superconducting coil is immersed and held at an extremely low temperature in the liquid helium H stored in the container main body 1001. The container main body 1001 has a coupling pipe 1002 connected with the service port 1100.

The service port 1100 includes an opening and closing portion 1110 that opens and closes when a current lead is connected with the superconducting coil or the liquid helium is replenished, a manometer 1120, and a discharging pipe 1130 that discharges the gaseous helium in the container main body 1001 through a discharging opening 1131. A check valve 1140 is attached to the middle of the discharging pipe 1130.

In the liquid helium container 1000, if external air flows into from the service port 1100, the external air is frozen so as to be solid air X, whereby the coupling pipe 1002 is blocked. Then, the manometer 1120 cannot measure the internal pressure of the container main body 1001 and thus cannot detect abnormal pressure even when abnormal pressure is generated in the container main body 1001. Therefore the maintenance of the device cannot be performed at a preferable timing.

In addition, if a physical feature of the liquid helium, that is, the temperature increases as the internal pressure in the container increases, is taken into account, it is effective to monitor the internal pressure of the container to judge the risk of quench generation (persistent current mode quench) when persistent current is used. However, as described above, since abnormal pressure cannot be detected when the coupling pipe 1002 is blocked, the risk of persistent current mode quench generation cannot be detected.

Meanwhile, it can be considered to install a manometer in the container to detect the internal pressure of the liquid helium container. However, in this case, external heat intrudes into the container through the manometer so as to facilitate the boil-off of the liquid helium, whereby the replenishing amount or frequency of the liquid helium increases and thus the running cost rises. Therefore, it is not practical to install in the container a device that detects the internal pressure of the liquid helium container.

### SUMMARY OF THE INVENTION

The present invention has been made to solve the above-mentioned problems, and an advantage of the invention is to provide a superconducting magnet device-monitoring system, a method of monitoring the superconducting magnet device and an MRI device that can detect an abnormal state of liquid helium and maintenance thereof can be performed at preferable timings even when solid air blocks a liquid helium container.

In addition, another advantage of the invention is to provide a superconducting magnet device-monitoring system, a method of monitoring the superconducting magnet device and an MRI device that can detect an abnormal state of the liquid helium and detect a risk of persistent current mode quench generation even when the solid air blocks the liquid helium container.

In order to achieve the above advantages, a superconducting magnet device-monitoring system according to the invention includes a detecting unit that detects the remaining amount of the liquid helium, in which a superconducting coil is immersed, stored in the liquid helium container of the superconducting magnet device; a remaining amount estimating unit that calculate an estimated remaining amount, which shows an estimated value of the remaining amount, on the basis of the remaining amount of liquid helium preliminarily detected by the detecting unit; and an output unit that outputs monitoring information on the superconducting magnet device on the basis of the detected remaining amount and the estimated remaining amount of the liquid helium.

In addition, the method of monitoring the superconducting magnet device according to the invention includes a step of detecting the remaining amount of the liquid helium, in which the superconducting coil is immersed, stored in the liquid helium container of the superconducting magnet device; a step of calculating the estimated remaining amount on the basis of the remaining amount of liquid helium preliminarily detected by the detecting unit; and a step of outputting the monitoring information on the superconducting magnet device on the basis of the detected remaining amount and the estimated remaining amount of the liquid helium.

Furthermore, the MRI device according to the invention includes a magnetostatic field coil that applies magnetostatic field to a subject; a superconducting magnet device-monitoring system that monitors the magnetostatic field coil; a gradient coil that applies gradient field to the subject, to which the magnetostatic field is already applied; an RF coil that receives nuclear magnetic resonance signals discharged from the subject; and a reconstruction unit that reconstructs a tomogram of the subject on the basis of the received nuclear magnetic resonance signals, and the superconducting magnet device-monitoring system includes the detecting unit that detects the remaining amount of the liquid helium, in which the superconducting coil, composing the magnetostatic coil, is immersed, in the liquid helium container; the remaining amount estimating unit that calculates the estimated remaining amount, which shows the estimated value of the remaining amount, on the basis of the remaining amount of the liquid helium preliminarily detected by the detecting unit; and the output unit that outputs the monitoring information on the superconducting magnet device on the basis of the detected remaining amount and the estimated remaining amount of the liquid helium.

According to the superconducting magnet device-monitoring system, the method of monitoring the superconducting magnet device, and the MRI device, the abnormal state of the liquid helium (particularly, pressure or temperature) can be detected even when the liquid helium container is blocked by solid air. As a result, the maintenance of the device can be performed at preferable timings, and the risk of persistent current mode quench generation can be detected.

Meanwhile, it is well known that the volume of liquid helium increases with the pressure. The invention detects an abnormal remaining amount with an abnormal pressure by relating the detected remaining amount of liquid helium with the internal pressure of the liquid helium container on the basis of the above feature of the liquid helium. In addition, the temperature of liquid helium increases with the pressure, whereby the invention detects an abnormal remaining amount with an abnormal temperature by relating the remaining amount of liquid helium with the temperature on the basis of the above two features of the liquid helium.

### BRIEF DESCRIPTION OF THE DRAWINGS

FIG. 1 is a view schematically showing an example of the overall structure of an embodiment of a superconducting magnet device-monitoring system according to the invention;

FIG. 2 is a cross-sectional view schematically showing an example of a liquid helium container of a superconducting magnet device monitored by the embodiment of the superconducting magnet device-monitoring system according to the invention;

FIG. 3 is a block diagram showing an example of the structure of a control system of the embodiment of the superconducting magnet device-monitoring system according to the invention;

FIG. 4 is a graph explaining about a method of calculating a linear estimated remaining amount of liquid helium by the embodiment of the superconducting magnet device-monitoring system according to the invention;

FIG. 5 is a graph illustrating a method of calculating a curved estimated remaining amount of liquid helium by the embodiment of the superconducting magnet device-monitoring system according to the invention;

FIG. 6 is a graph showing an example of an allowable range of the estimated remaining amount of liquid helium in the embodiment of the superconducting magnet device-monitoring system according to the invention;

FIG. 7 is a flow chart showing an example of a processing sequence performed by the embodiment of the superconducting magnet device-monitoring system according to the invention;

FIG. 8 is a graph showing an example of a relationship between the remaining amount of liquid helium and an internal pressure of the liquid helium container in the embodiment of the superconducting magnet device-monitoring system according to the invention;

FIG. 9 is a block diagram showing an example of the structure of a control system of a modification of the superconducting magnet device-monitoring system according to the invention;

FIG. 10 is a flow chart showing an example of a processing sequence performed by the modification of the superconducting magnet device-monitoring system according to the invention;

FIG. 11 is a block diagram showing the rough structure of an embodiment of an MRI device, to which the superconducting magnet device-monitoring system according to the invention is applied; and

FIG. 12 is a cross-sectional view showing the rough structure of the liquid helium container in the related art.

### DESCRIPTION OF THE PREFERRED EMBODIMENTS

Preferred embodiments of a superconducting magnet device-monitoring system and a method of monitoring the superconducting magnet device by the above system will be described in detail with reference to the accompanying drawings. In the following embodiments, the system is applied to an MRI device.

1. Structure of System

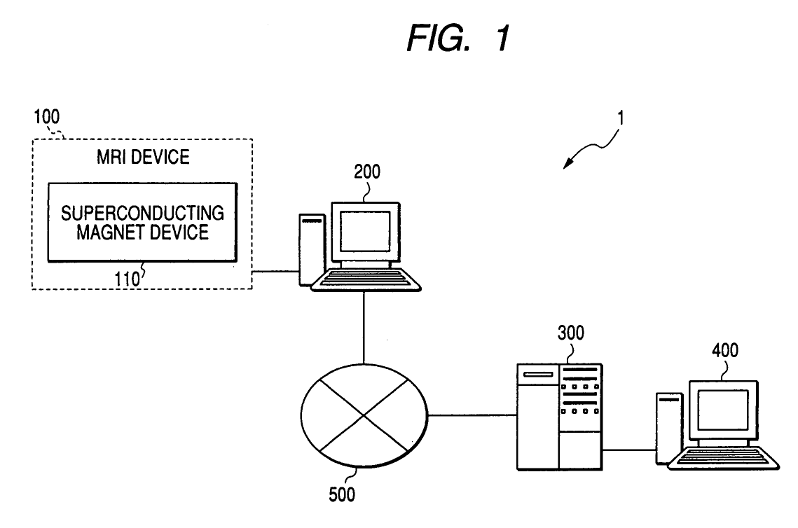

First of all, the structure of the superconducting magnet device-monitoring system according to the invention will be described with reference to FIG. 1. FIG. 1 shows the rough structure of the superconducting magnet device-monitoring system 1 for monitoring the superconducting magnet device 110, which is applied to the MRI device 100.

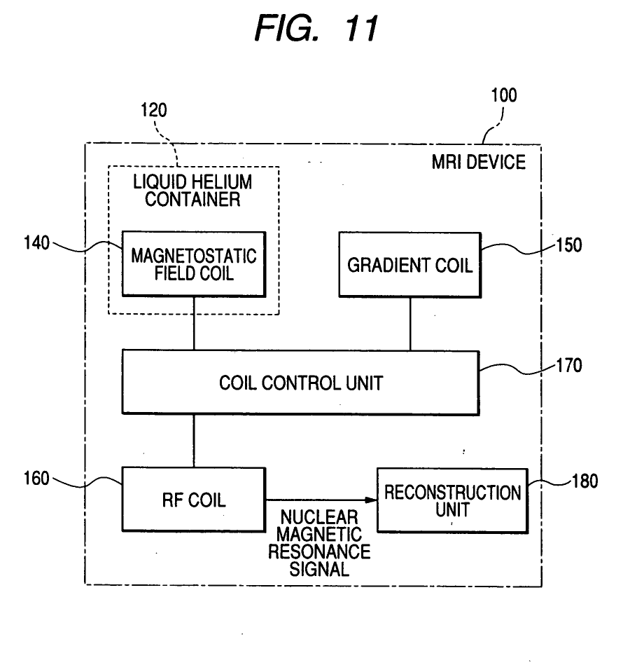

Here, the rough structure of the MRI device 100 that creates a tomogram of a subject will be simply described with reference to FIG. 11. Like the MRI device in the related art, the MRI device 100 includes a magnetostatic field coil 140, a gradient coil 150, a RF (Radio Frequency) coil 160, a coil control unit 170 and a reconstruction unit 180. The magnetostatic field coil 140 is disposed in a liquid helium container 120 to be described below. The superconducting magnet device 110 of the present embodiment includes the magnetostatic field coil 140.

The magnetostatic field coil 140 includes a superconducting coil that generates a uniform and stable magnetostatic field to apply the field to the subject. The gradient coil 150 applies a gradient field, which is used to identify positions in the subject, to the subject in the magnetostatic field applied by the magnetostatic field coil 140. The RF coil 160 receives nuclear magnetic resonance signals discharged from the subject. The nuclear magnetic resonance signals are discharged so as to correspond to a high-frequency magnetic field (RF magnetic field) which is applied to the subject by the RF coil 160 or the other RF coil.

The coil control part 170, which comprises gradient Amp, RF Amp, and static field Coil power supply, controls the electric power supplying to the magnetostatic field coil 140; the gradient coil 150; and the RF coil 160, and the applying timing of magnetic field by the gradient coil 150 or the nuclear magnetic resonance signal generating RF coil.

The reconstruction unit 180 receives the input of the nuclear magnetic resonance signals received by the RF coil 160 and reconstructs the tomogram of the subject on the basis of the nuclear magnetic resonance signals.

Meanwhile, a superconducting magnet device-monitoring system 1 includes a console 200 for operating the MRI device 100, a server 300 that provides the monitoring service of the MRI device 100 (including the superconducting magnet device 110) through an internet 500, and a monitoring terminal 400 connected with the server 300. The superconducting magnet device-monitoring system 1 also includes a liquid-level meter or the like provided at the superconducting magnet device 110 (described below).

The console 200 and the server 300 are connected with each other through the internet 500 so as to communicate with each other. Meanwhile, the server 300 can provide service to the arbitrary number of MRI devices, even though FIG. 1 shows that the server 300 provides service to only one MRI device 100 for simplification.

The MRI device 100 and the console 200 are installed at medical institutions such as clinic or the like. In addition, the server 300 and the monitoring terminal 400 are installed at, for example, a maintenance service providing company or the like of an MRI device 100.

The console 200 operates the MRI device 100 and, in addition, transmits measured data showing the state of the superconducting magnet device 110, for example, the internal pressure or liquid level of the liquid helium container, to the server 300 periodically or on demand. Meanwhile, the measured data or the like may be sent by a dedicated data transmitting apparatus. The server 300 analyzes the measured data or the like transmitted from the console 200 or manages various data relating to the maintenance service of the MRI device 100. The monitoring terminal 400 obtains the measured data or the like accumulated in the server 300 so as to display the data and inputs or rewrites various data on demand of an operator.

2. Structure of Superconducting Magnet Device

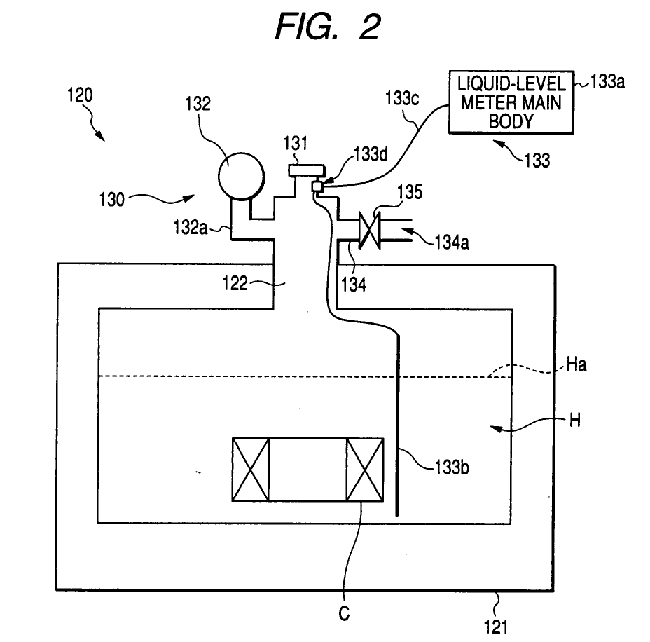

Next, the structure of the superconducting magnet device 110 will be described. The superconducting magnet device 110, like the superconducting magnet device in the related art, includes a liquid helium container that stores liquid helium, and a superconducting coil immersed in the liquid helium. Hereinafter, an example of the structure of the liquid helium container relating to the invention will be described with reference to FIG. 2.

The liquid helium container 120 shown in FIG. 2 includes a container main body 121, and a service port 130. The container main body 121 has the double wall structure forming a vacuum layer so as to reduce heat transmission between the inside and outside of the container. A superconducting coil C is installed in the container main body 121 and is immersed in a liquid helium H stored in the container main body 121 so as to be held at an extremely low temperature. A coupling pipe 122 connected with the service port 130 is formed at the container main body 121.

The service port 130 is provided with an opening and closing portion 131, a manometer 132, a liquid-level meter 133 and a discharging pipe 134. The opening and closing portion 131 opens and closes when a current lead is connected to the superconducting coil C or when the liquid helium H is replenished to the container main body 121. The manometer 132 is provided at a front end of a pressure detecting pipe 132, which is branched off from the coupling pipe 122. The manometer 132 is composed of a mechanical manometer or an electronic pressure transducer like the manometer in the related art.

The liquid-level meter 133 is an example of ‘a detecting unit’, and, like the liquid-level meter in the related art, includes a liquid-level meter main body 133a installed at the outside of the liquid helium container 120, a composite wire 133b of a superconductor and a normal conductor installed in the liquid helium container 120, and a measuring wire 133c that combines the liquid-level meter main body and the composite wire. The measuring wire 133c connects the liquid-level meter main body 133a with the composite wire 133b through a measuring wire pot 133d formed on a wall surface of the coupling pipe 122. The composite wire 133b is installed substantially perpendicular to a liquid surface Ha of the liquid helium H. The liquid-level meter main body 133a applies constant current to the composite wire 133b and measures the resistance simultaneously so as to detect the level of the liquid surface Ha.

The detection result of the liquid-level meter 133 is usually displayed in percentage, that is, the result displays 0% when the liquid surface Ha exists at a lower end of the composite wire 133b, and 100% when the liquid surface Ha exists at a upper end of the composite wire 133b. Meanwhile, the detection result can be displayed by the distance (centimeter, inch or the like) from the lower end (upper end) of the composite wire 133b to the liquid surface Ha or the remaining amount (liter) calculated from the detected liquid level.

Since the discharging pipe 134 is to discharge the gaseous helium in the container main body 121 through the discharging opening 134a, the discharging pipe 134 is branched off from the coupling pipe 122. Since check valve 1140 is provided on the discharging pipe 134, if the pressure of the gaseous helium in the container main body 121 exceeds a predetermined value, the check valve 1140 passes the gaseous helium toward the discharging opening 134a. In addition, the check valve 1140 prevents external air from flowing into the container main body 121.

3. Structure of Control System

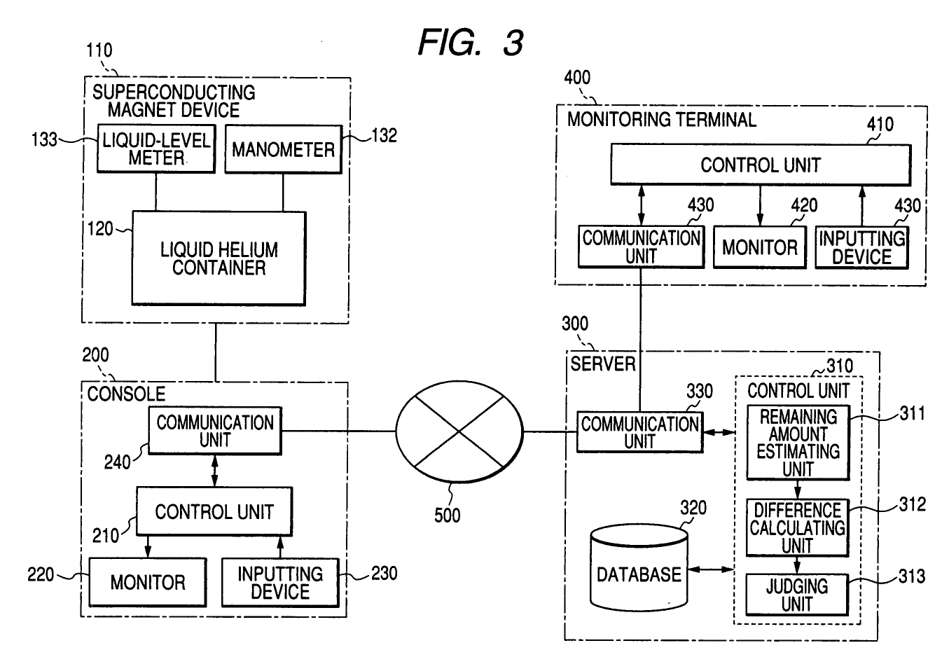

Next, the structure of a control system of the superconducting magnet device-monitoring system 1 will be described. FIG. 3 shows an example of the structure of the control system of the superconducting magnet device-monitoring system 1.

3-1. Console

The console 200 includes a control unit 210, a monitor 220, an input device 230 and communication unit 240. The monitor 220 is a display such as an LCD, a CRT or the like. The input device 230 is an input device, with which an operator of the console 200 operates the system or inputs data, such as a keyboard, a mouse, a trackball, an operating panel or the like. The communication unit 240 includes a modem or the like for communicating data through the internet 500.

The control unit 210 of the console 200 includes an arithmetic and control unit such as a CPU or the like, and a storage unit such as RAM, ROM, hard disc drive or the like. The storage unit previously stores various computer programs. The CPU of the control unit 210 executes the computer programs so as to control the operation of the MRI device 100, the measurement using the manometer 132 or the liquid-level meter 133, and the communication including the measured data transmission.

3-2. Server

The server 300 includes a control unit 310, a database 320 and a communication unit 330. The database 320 is a mass storage unit that stores various data relating to the maintenance service of the MRI device 100. The communication unit 330 includes an internet connecting modem, and a network adaptor for data-communicating with the monitoring terminal 400 through a communication line such as LAN or the like.

The control unit 310 of the server 300 includes an arithmetic and control unit such as CPU or the like, and a storage unit such as a RAM, a ROM, a hard disc drive or the like. The storage unit stores computer programs for the maintenance service. The control unit 310 controls the communication, the data storage or scanning with respect to the database 320, and the communication with the monitoring terminal 400 through the internet 500.

In addition, the control unit 310 includes a remaining amount estimating unit 311, a difference calculating unit 312, and a judging unit 313 in order to monitor the internal pressure of the liquid helium container 120. Each of the above units 311 to 313 is composed of a CPU that executes the above computer programs.

The remaining amount estimating unit 311 calculates an estimated remaining amount, which estimates the remaining amount in the future, on the basis of the remaining amount of the liquid helium H detected by the liquid-level meter 133. The calculation is performed as described below.

As a precondition of the calculation, the liquid-level meter 133 detects the level of the liquid surface Ha of the liquid helium H plural times. The level of the liquid surface is detected, for example, everyday for a month (total about 30 times). In addition, the relationship between the level of the liquid surface Ha and the remaining amount of the liquid helium H depends on the installing location of the liquid-level meter 133 and the size and shape of the internal region of the liquid helium container 120, and the relationship has already been known. That is, it is possible to extract the remaining amount of the liquid helium H from the level of the liquid surface Ha and vice versa.

The remaining amount estimating unit 311 calculates the Boil-Off-Rate (B.O.R.) of the liquid helium on the basis of plural detection results obtained by the liquid-level meter 133. B.O.R. is an index showing a liquid helium amount-reducing speed due to evaporation and defined as B.O.R.=ΔV/Δt, in which ΔV is the change in amount of the liquid helium H during a time Δt. It can be known from the above definition that B.O.R. has negative values. In this case, Δt is defined as, for example, a day, a week, a month or the like, whereby B.O.R. shows the reducing amount of the liquid helium during a day, a week and a month individually.

Because the relationship between the remaining amount of the liquid helium H and the level of the liquid surface Ha is already known, as described above, B.O.R. can be extracted by using the changing amount of the liquid surface level ΔL during the time Δt. For example, if the internal region of the liquid helium container 120 is cubic (see FIG. 2), ΔV=S×ΔL, in which S is a base area, B.O.R. is defined as (S×ΔL)/Δt. Meanwhile, when the shape of the internal region of the liquid helium container 120 changes in the longitudinal direction of the composite wire 133b of the liquid-level meter 133 (for example, when the shape of the internal region is circular), the relationship between ΔV and ΔL is defined in consideration of the changing degree of the shape of the internal region.

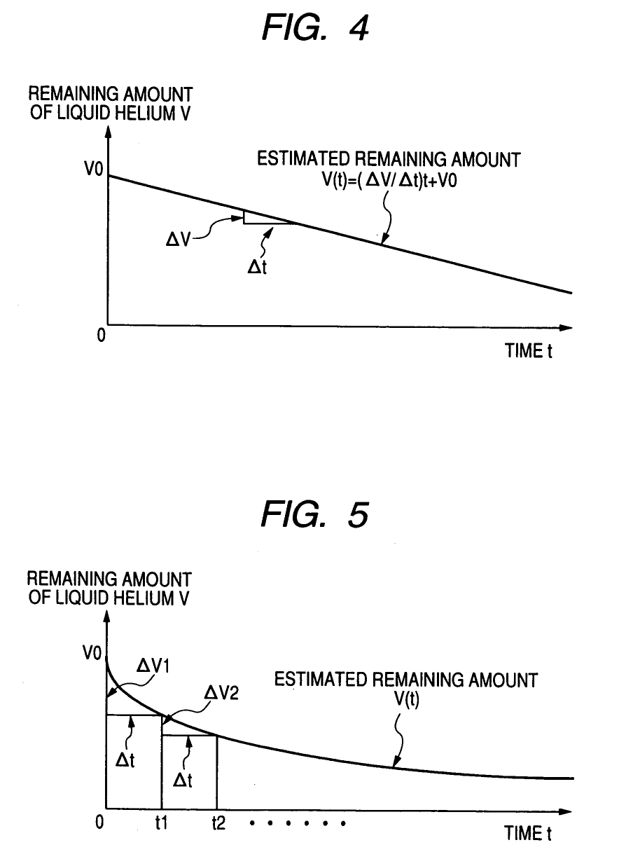

In addition, the remaining amount estimating unit 311 calculates an estimated remaining amount of the liquid helium H in the future with reference to the calculated B.O.R. FIGS. 4 and 5 show an example of the estimated remaining amount of the liquid helium based on B.O.R. Meanwhile, even though the example uses an estimation of the change in the remaining amount V of the liquid helium H with time, it is also possible to use an estimation of the change in the liquid surface Ha level of the liquid helium H with time.

The estimated remaining amount V(t) shown in FIG. 4 illustrates estimated remaining amounts calculated from one B.O.R. value or a plurality of B.O.R. values.

In FIG. 4, the estimated remaining amount V(t) is extracted from a plurality of B.O.R. values obtained during (Δt=t(n+1)−tn) and involves the change in the liquid helium H amount reducing speed with time by using B.O.R.=ΔV1/Δt, in which t=0 to t1, B.O.R.=ΔV2/Δt, in which t=t1 to t2, . . . .

Meanwhile, if the estimation accuracy is taken into account, the estimated remaining amount in FIG. 5 prefers to the estimated remaining amount in FIG. 4. Even though FIG. 5 displays only two B.O.R. values for figure-simplification, the number of B.O.R. values used for the estimated remaining amount calculation is not fixed. For example, if the liquid surface level is detected everyday for one month, as described above, the estimated remaining amount is calculated on the basis of about 30 B.O.R. values.

The control unit 310 sets an allowable difference range of the calculated estimated remaining amount V(t) (sometimes called an allowable difference range). For example, the allowable difference range can be defined as the amount of the liquid helium or the like corresponding to 1% of detected value of the liquid-level meter 133. Meanwhile, it is preferable to use previously set values as the allowable difference range and to set the allowable difference range individually for each calculated estimated remaining amount V(t).

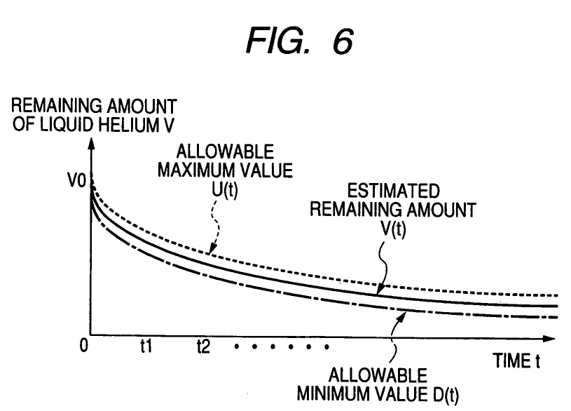

FIG. 6 shows an example of the allowable difference range corresponding to the estimated remaining amount V(t) of FIG. 5. The allowable difference range shown in FIG. 6 is set by the maximum value U(t) and minimum value D(t) of the allowable range during a time t. In this case, the difference between the estimated remaining amount V(t) and the maximum value U(t), and the difference between the estimated remaining amount V(t) and the minimum value D(t) can be equal (for example, both of the maximum and minimum values are about 1%) or different (for example, the maximum value is about 1%, and the minimum value is about 1.5%). In addition, it is possible to set only either the maximum value U(t) or minimum value D(t) of the allowable range according to the necessity.

Next, the difference calculating unit 312 will be described. The difference calculating unit 312 calculates the difference between the remaining amount of the liquid helium H based on the new detection result of the liquid-level meter 133 and the estimated remaining amount detected by the remaining amount estimating unit 311. For example, if Vs is the remaining amount of the liquid helium H detected at the time t=s, the difference calculating unit 312 calculates the difference δV(s) between the remaining amount Vs and the estimated remaining amount V(s) at the time t=s.

Meanwhile, the difference can be calculated in the difference calculating unit 312 by extracting an absolute value of the difference between the remaining amount Vs and the estimated remaining amount V(s), that is, δV(s)=|Vs−V(s)| or the difference between the remaining amount Vs and the estimated remaining amount V(s), that is, δV(s)=Vs−V(s). The former is preferable when the difference between the estimated remaining amount V(t) and the maximum value U(t), and the difference between the estimated remaining amount V(t) and the minimum value D(t) are set equal. On the other hand, the latter is preferably used when the difference between the estimated remaining amount V(t) and the maximum value U(t), and the difference between the estimated remaining amount V(t) and the minimum value D(t) are set different.

The judging unit 313 judges whether the difference δV(s) calculated by the difference calculating unit 312 is in the above-mentioned allowable difference range. More specifically, the judging unit 313 judges whether the calculated difference δV(s) is not more than the amount of the liquid helium corresponding to, for example, 1% of the detected value of the liquid-level meter 133. Referring to FIG. 6, when the difference δV(s) is judged not more than 1% of the detected liquid level, the remaining amount Vs of the liquid helium H at the time t=s is in the range between the minimum value D(s) and maximum value U(s) of the allowable range. On the other hand, when the difference δV(s) is judged to exceed 1% of the detected liquid level, the remaining amount V(s) is not in the allowable range.

3-3. Monitoring Terminal

The monitoring terminal 400 includes a control unit 410, a monitor 420, an input device 430, and a communication unit 440. The monitor 420 and the input device 430 have been described in the section of the console 200. The communication unit 440 includes a network adaptor or the like for data-communicating with the server 300 through a communication line such as LAN or the like.

The control unit 410 of the monitoring terminal 400 includes an arithmetic and control unit such as CPU or the like, and a storage unit such as a RAM, a ROM, a hard disc drive or the like. The storage unit previously stores various computer programs. The CPU of the control unit 410 executes the computer programs so as to process various data relating to the maintenance service of the MRI device 100. Meanwhile, when the server 300 and the monitoring terminal 400 composes a server/client system, the CPU of the control unit 410 can do the same thing on the basis of the computer program stored in the server 300.

4. Process Sequence

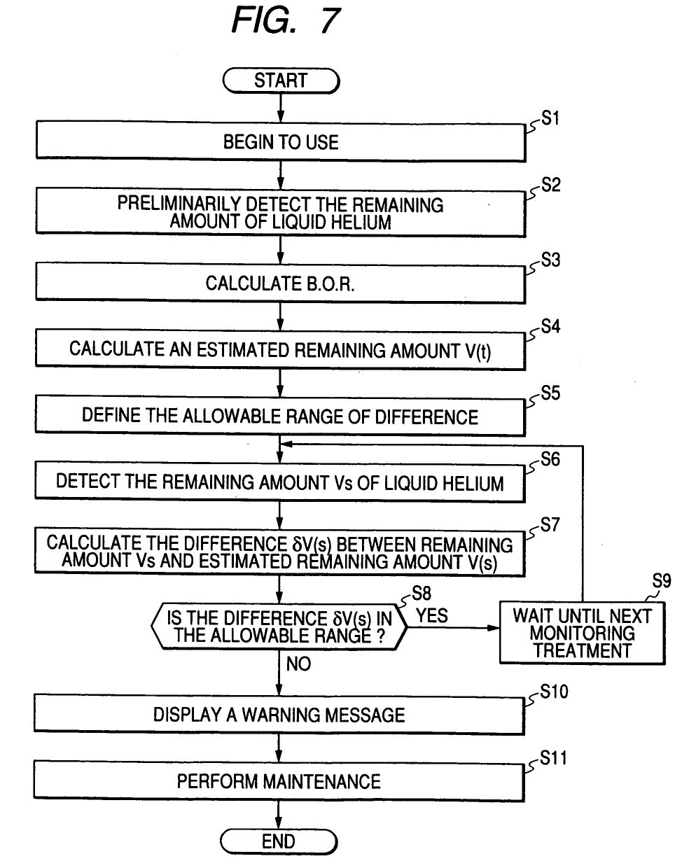

A sequence of executing the superconducting magnet device-monitoring system 1, composed as above, will be described with reference to FIG. 7. The flow chart in FIG. 7 shows an example of a series of process sequence from the beginning of the operation to the maintenance of the superconducting magnet device 100 performed when an abnormal state of the liquid helium is detected.

The superconducting magnet device 110 (MRI device 100) begins to be used by replenishing the liquid helium H into the liquid helium container 120 (S1). After the beginning of the operation, the liquid-level meter 133 detects the liquid surface level (remaining amount) of the liquid helium H preliminarily at predetermined intervals (for example, everyday) for a predetermined period (for example, one month) (S2). The detection is carried out according to the control of the control unit 210 of the console 200. Each detection result is sent to the server 300 by the console 200 and accumulated in the database 320.

When a predetermined number (for example, about 30) of preliminary detection results of the remaining amount of the liquid helium H is obtained, the remaining amount estimating unit 311 of the server 300 calculates B.O.R. from the detection result (S3) and the estimated remaining amount V(t) (S4), as shown in FIG. 4 or 5. The control unit 310 sets an allowable difference range of the estimated remaining amount V(t) (S5). The estimated remaining amount V(t) calculated in step S4 and the allowable difference range set in step S5 are stored in the database 320. Meanwhile, when the allowable difference range is set as a default range, it is needless to perform step S5.

So far, a preliminary process for monitoring the remaining amount of the liquid helium H has been described. Hereinafter, an actual process for monitoring the remaining amount of the liquid helium H will be described.

At the time t=s, the liquid-level meter 133 detects the liquid surface level (remaining amount Vs) of the liquid helium H in the liquid helium container 120 (S6). The detection result Vs is sent to the server 300. The liquid-level meter 133 detects the liquid surface level periodically, for example, every week, by the control of the control unit 210 of the console 200.

The difference calculating unit 312 of the server 300 calculates the difference δV(s) between the new detection result Vs of the remaining amount of the liquid helium H and the estimated remaining amount V(s), which is the estimated remaining amount V(t) calculated at the time t=s in step S4 (S7).

The judging unit 313 judges whether the difference δV(s) is in the allowable difference range set in step S5 (S8). If the judging unit 313 judges that the difference δV(s) is in the allowable range (S8; Y), the system gets into a wait state without performing a particular process until the liquid-level meter 133 detects the liquid surface level again (S9).

In addition, when the judging unit 313 judges that the difference δV(s) is in the allowable range (S8; Y), the monitor 420 of the monitoring terminal 400 can display a message such as ‘liquid helium is in the normal state’ or the like by an indication of the server 300. Meanwhile, the monitor 220 of the console 200 can display the same message.

Meanwhile, when the judging unit 313 judges that the difference δV(s) is not in the allowable range (S8; N), the control unit 310 of the server 300 transmits control signals to the monitoring terminal 400 so as to make the monitor display a warning message such as ‘liquid helium is not in the normal state’ or the like (S10). In this case, the monitor 220 of the console 200 may display the same warning message. In addition, it is also possible to output a warning sound or the like. Furthermore, it is also possible to transmit a warning message to a portable terminal device (mobile phone, PDA or the like) of a service engineer through an electronic mail. In step S10, the warning message can be noticed by an arbitrary method.

When the service engineer senses the warning message or sound, the service engineer performs the maintenance of the liquid helium container 120 (S11). In the maintenance, it is checked whether the air is frozen in the liquid helium container 120 or the liquid helium container 120 is blocked, and the frozen air is removed. In addition, the service port 130 is checked. With the above processes, a process of monitoring the liquid helium H is ended.

At this point, the estimated remaining amount V(t) can be corrected on the basis of the detection result of the remaining amount obtained from the monitoring process (step 6) and then can be used in the next monitoring process.

The monitor 420 that displays the warning message in step S10, a sound outputting device (speaker, sound outputting circuit or the like) that outputs the warning sound, or the portable terminal device is an example of ‘an alarm unit’ of the invention.

5. Operation and Effect

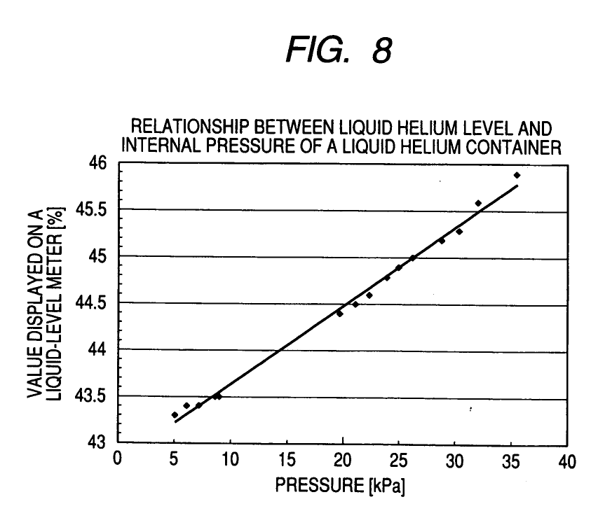

The physical feature of the liquid helium, which is an assumption of the operation and effect of the embodiment, will be described. As described in [the description of the related art], if the internal pressure of the liquid helium container 120 increases, the temperature of the liquid helium H increases. In addition, as the internal pressure of the liquid helium container 120 increases, the amount (volume) of the liquid helium also increases. FIG. 8 shows the relationship between the amount of the liquid helium H (detected value of the liquid-level meter 133) and the internal pressure of the liquid helium container 120 (actually measured value). FIG. 8 shows that values measured by the liquid-level meter 133 (displayed values) change almost linearly from about 43.2 to 45.8% with respect to the internal pressure of the container from about 5 to 35 kPa. By using the above feature of the liquid helium, the following operation and effect can be obtained.

According to the superconducting magnet device-monitoring system 1 of the embodiment, first of all, the estimated remaining amount V(t) of the liquid helium H is extracted from the preliminary detection result of the remaining amount of the liquid helium H obtained by the liquid-level meter 133. The estimated remaining amount V(t) is a remaining amount of the liquid helium H estimated at an arbitrary time t in the future. In addition, the allowable difference range of the remaining amount Vt of the liquid helium H with respect to the estimated remaining amount V(t) is set at the arbitrary time t. The above is a preliminary process. In an actual monitoring process (time t=s), if the difference δV(s) between the detection result Vs of the remaining amount of the liquid helium H and the estimated remaining amount V(s) exceeds the allowable difference range, a warning message or the like is notified.

Meanwhile, in the embodiment, the allowable difference range is set to correspond to 1% of the detected value of the liquid-level meter 133. Referring to FIG. 8, the allowable difference range of the internal pressure corresponding to 1% of the detected value is about 2.3 kPa. The allowable difference range of the remaining amount V(t) of the liquid helium H is set to correspond to the allowable difference range of the internal pressure of the container.

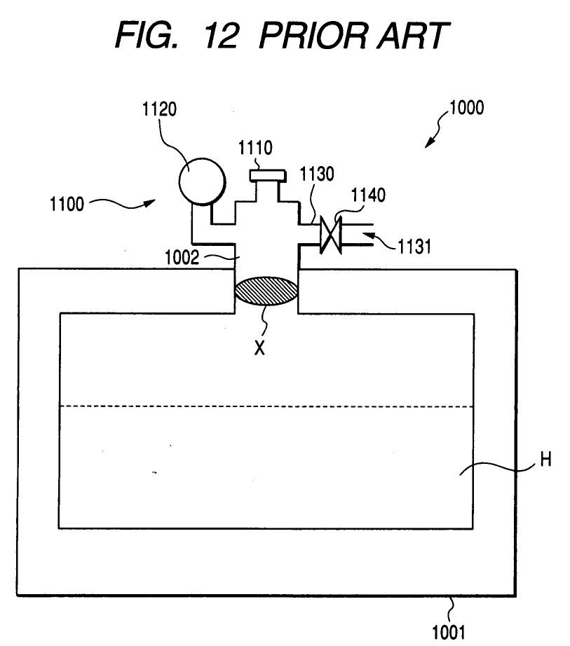

The difference δV(s) exceeding the allowable range means that the difference of the internal pressure of the container exceeds the allowable range. The abnormal internal pressure of the container implies that the liquid helium container 120 is blocked by solid air (see FIG. 12). In addition, the blocked liquid helium container 120 implies the inflow of external air through the service port 130 or the malfunction of the check valve 1140, and the increased risk of persistent current mode quench due to the increase of the temperature accompanied by the abnormal pressure.

Therefore, since the embodiment can detect an abnormal internal pressure of the container even when the coupling pipe 122 of the liquid helium container 120 is blocked by the solid air, the maintenance of the system can be performed at preferable timings. In addition, since the risk of persistent current mode quench can be detected, the countermeasures can be devised in an early stage. Furthermore, the running cost for the operation of the system does not rise.

Still furthermore, even though the superconducting magnet device in the related art includes the liquid-level meter in the liquid helium container, if the superconducting magnet device adopts the embodiment, it is not necessary to install hardware additionally, whereby the system-introducing cost is reduced.

6. Modification

The above-mentioned structure is just an example of the structure for embodying the invention, and various modifications can be adopted within the purport of the invention. For example, it is possible to embody the following modifications.

In the above embodiment, whether the liquid helium container is in the normal state is judged by judging whether the difference δV(s) between the estimated remaining amount V(s) at the time t=s and the remaining amount Vs is in the allowable range. However, it is also possible to judge whether the liquid helium container is in the normal state as described below.

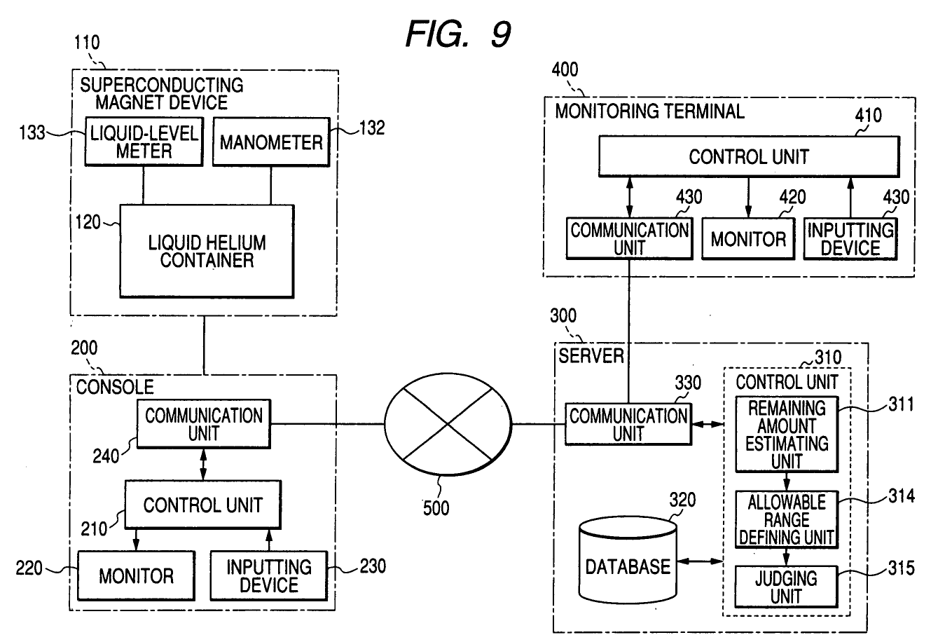

FIG. 9 shows the structure of the control system of the superconducting magnet device-monitoring system of the modification. The modification has almost the same structure as that of the embodiment shown in FIG. 3. What is different from the embodiment is only that the control unit 310 of the server 300 includes an allowable range setting unit 314 and a judging unit 315.

The allowable range setting unit 314 sets the allowable range of remaining amount with respect to the estimated remaining amount V(t) calculated by the remaining amount estimating unit 311. The allowable range setting unit 314 extracts the maximum value U(t)/minimum value D(t) of the allowable range by adding and/or subtracting, for example, the previously set difference of remaining amount (corresponding to 1% of the detected value of the liquid-level meter 133) to and/or from the calculated estimated remaining amount V(t) (see a graph in FIG. 6).

The judging unit 315, different from the judging unit 313 of the embodiment, judges whether the remaining amount Vs of the liquid helium H detected by the liquid-level meter 133 at the time t=s is in the allowable range set by the allowable range setting unit 314. That is, the judging unit 315 judges whether D(s)≦Vs≦U(s) at the time t=s when, for example, both of the maximum value U(t) and the minimum value D(t) of the allowable range are set. In addition, the judging unit 315 judges whether Vs≦U(s) or Vs≧D(s) when only either the maximum value U(t) or the minimum value D(t) is set.

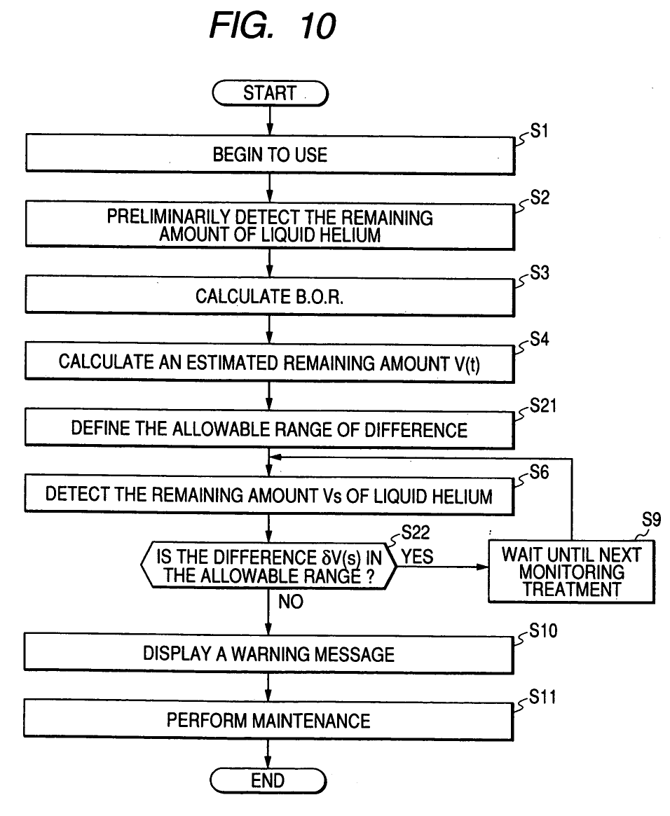

The flow chart in FIG. 10 shows an example of the process sequence of the modification. In the flow chart, the same reference numerals are added to the same processes as those of the embodiment. Such processes have been described in the section of the embodiment, whereby the detailed description will be omitted.

The process sequence of the modification is equal to that of the embodiment until the calculation of the estimated remaining amount V(t) in step S4. The allowable range setting unit 314 sets the allowable range of remaining amount with respect to the calculated estimated remaining amount V(t) (S21). The set allowable remaining amount range is stored in the database 320.

When the liquid surface level (remaining amount Vs) of the liquid helium H in the liquid helium container 120 is detected at the time t=s (S6), the judging unit 315 judges whether the newly detected remaining amount Vs is in the allowable remaining amount range set in step S21 (S22). If the judging unit 315 judges that the detected remaining amount Vs is in the allowable remaining amount range (S22; Y), the system gets into a wait state until the liquid-level meter 133 detects the liquid surface level again (S9).

On the other hand, if the judging unit 315 judges that the remaining amount V(s) is not in the allowable remaining amount range (S22; N), the control unit 310 of the server 300 outputs a warning message or sound to the monitoring terminal 400 (S10). When the service engineer senses the warning message or sound, the service engineer performs maintenance of the liquid helium container 120 (S11).

Since the modification, like the embodiment, can detect abnormal internal pressure or temperature of the container on the basis of the remaining amount of the liquid helium H, even when the liquid helium container 120 is blocked by solid air, the maintenance of the system can be performed at preferable timings and the risk of persistent current mode quench can be detected in advance.

6-1. Other Modifications

Even though the remaining amount estimating unit 311, the difference calculating unit 312 and the judging unit 313 are provided at the server 300 in the above example, the above units can be provided at the console 200 or monitoring terminal 400. For example, if the units are provided at the console 200, the judging result of the judging unit 313 is sent to the server 300, and then the warning message of the monitoring terminal 400 is displayed. In addition, the above units do not have to be provided at the same devices. Such modifications can also be applied to the above modification.

The system according to the invention does not have to include all of console, server, and monitoring terminal and can include the other units. In addition, it is not necessary to communicate with a maintenance service company through the console, and it is possible to communicate with the maintenance service company through, for example, the server of the medical institution. Furthermore, it is also possible to connect a communication unit such as modem or the like to the superconducting magnet device (MRI device or the like) directly for communication. Still furthermore, it is also possible to connect a maintenance service computer device to the superconducting magnet device in order to control the operation of the liquid-level meter or manometer or to communicate with the maintenance service company.

An ‘MRI device’ according to the invention includes a device adopting the system structure shown in FIG. 3 or 9.

In addition, the superconducting magnet device-monitoring system 1 does not necessarily output the judging result of the judging units 313 and 315 as the monitoring information on the superconducting magnet device 110. For example, it is possible to merely display the remaining amount of the liquid helium detected by the detecting unit of the liquid-level meter 133 or the like and the estimated remaining amount calculated by the remaining amount estimating unit 311 or information obtained from the estimated remaining amount on the monitor 420 as the monitoring information on the superconducting magnet device 110.

In this case, a user detects the abnormality of the superconducting magnet device 110 by referring to the displayed monitoring information on the superconducting magnet device 110. In addition, it is desirable to prepare a judging table separately in order to judge whether the superconducting magnet device 110 is in the normal state on the basis of the estimated remaining amount of the liquid helium and the detected remaining amount of the liquid helium.

The judging table can be prepared by relating, for example, the estimated remaining amount of the liquid helium and the maximum and minimum values of the allowable remaining amount of the liquid helium or by relating the allowable deviating amount (value of difference or ratio) of the liquid helium to the estimated remaining amount of the liquid helium.

In addition, if a user can refer to the judging table in the form of paper or electronic information, it is needless to provide components such as the judging units 313 and 315 or the like in the superconducting magnet device-monitoring system 1, whereby the structure of the superconducting magnet device-monitoring system 1 can be simplified. Furthermore, the user does not have to set the allowable range. Still furthermore, even when the allowable range of the remaining amount of the liquid helium is different for each user or superconducting magnet device 110, a plurality of different allowable ranges can be set freely in the form of the judging table, whereby it is needless to set parameters of the superconducting magnet device-monitoring system 1 and thus the superconducting magnet device-monitoring system 1 can be standardized.

What is claimed is:

1. A superconducting magnet device-monitoring system, comprising:
a detecting unit that detects a remaining amount of liquid helium, and in which a superconducting coil is immersed, stored in a liquid helium container of a superconducting magnet device;
a remaining amount estimating unit that calculates an estimated remaining amount of liquid helium, and which shows an estimated value of the remaining amount, on the basis of the remaining amount of liquid helium preliminarily detected by the detecting unit; and
an output unit that outputs monitoring information on a superconducting magnet device on the basis of the detected remaining amount and the estimated remaining amount of liquid helium.

2. The superconducting magnet device-monitoring system according to claim 1,
wherein the output unit outputs the remaining amount and the estimated remaining amount of liquid helium as the monitoring information.

3. The superconducting magnet device-monitoring system according to claim 1, further comprising:
a difference calculating unit that calculates a difference between the remaining amount of liquid helium newly detected by the detecting unit after the preliminary detection and the calculated estimated remaining amount corresponding to the newly detected remaining amount; and
a judging unit that judges whether the calculated difference is in a predetermined allowable range,
wherein the output unit outputs a judging result of the judging unit as the monitoring information.

4. The superconducting magnet device-monitoring system according to claim 1, further comprising:
an allowable range setting unit that sets the allowable range of the remaining amount with respect to the calculated estimated remaining amount; and
a judging unit that judges whether the remaining amount of liquid helium newly detected by the detecting unit after the preliminary detection is in a set allowable range,
wherein the output unit outputs the judging result of the judging unit as the monitoring information.

5. The superconducting magnet device-monitoring system according to claim 1,
wherein the preliminary detection of the remaining amount of liquid helium by the detecting unit is carried out plural times, and the remaining amount estimating unit calculates a boil-off rate of liquid helium on the basis of the plural remaining amounts obtained by the plurality of preliminary detections and then calculates the estimated remaining amount on the basis of the calculated boil-off rate.

6. The superconducting magnet device-monitoring system according to claim 1,
wherein the detecting unit includes a liquid-level meter that detects a liquid surface level of liquid helium stored in the liquid helium container.

7. The superconducting magnet device-monitoring system according to claim 3,
wherein the output unit includes an alarm unit that warns when the judging unit judges that the difference is not in the predetermined allowable range.

8. The superconducting magnet device-monitoring system according to claim 4,
wherein the output unit includes an alarm unit that warns when the judging unit judges that the remaining amount of liquid helium is not in the set allowable range.

9. A method of monitoring a superconducting magnet device, comprising:
detecting a remaining amount of liquid helium, in which a superconducting coil is immersed, stored in a liquid helium container of the superconducting magnet device;
calculating an estimated remaining amount, which shows an estimated value of the remaining amount, on the basis of a preliminarily detected remaining amount of liquid helium; and
outputting monitoring information on a superconducting magnet device on the basis of a detected remaining amount and an estimated remaining amount of liquid helium.

10. The method of monitoring the superconducting magnet device according to claim 9,
wherein the remaining amount and the estimated remaining amount of liquid helium are outputted as the monitoring information.

11. The method of monitoring the superconducting magnet device according to claim 9, further comprising:
calculating a difference between the remaining amount of liquid helium newly detected after the preliminary detection and the calculated estimated remaining amount corresponding to the newly detected remaining amount; and
judging whether the calculated difference is in a predetermined allowable range,
wherein a judging result is outputted as the monitoring information.

12. The method of monitoring the superconducting magnet device according to claim 9, further comprising:
setting an allowable range of the remaining amount with respect to the calculated estimated remaining amount; and
judging whether the remaining amount of liquid helium newly detected after the preliminary detection is in a set allowable range,
wherein a judging result is outputted as the monitoring information.

13. The method of monitoring the superconducting magnet device according to claim 9,
wherein the preliminary detection of the remaining amount of liquid helium is carried out plural times, and a boil-off rate of liquid helium is calculated on the basis of the plural remaining amounts obtained by the plurality of preliminary detections and then the estimated remaining amount is calculated on the basis of the calculated boil-off rate.

14. The method of monitoring the superconducting magnet device according to claim 9,
wherein a liquid surface level of liquid helium stored in the liquid helium container is detected by a liquid-level meter.

15. The method of monitoring the superconducting magnet device according to claim 11,
wherein warning is carried out when the difference is judged not in the predetermined allowable range.

16. The method of monitoring the superconducting magnet device according to claim 12,
wherein warning is carried out when the remaining amount of liquid helium is judged not in the set allowable range.

17. An MRI device, comprising:
a magnetostatic field coil that applies magnetostatic field to a subject;
a superconducting magnet device-monitoring system that monitors the magnetostatic field coil;
a gradient coil that applies gradient field to the subject, to which the magnetostatic field is already applied;
an RF coil that receives nuclear magnetic resonance signals discharged from the subject; and
a reconstruction unit that reconstructs a tomogram of the subject on the basis of the received nuclear magnetic resonance signal,
wherein the superconducting magnet device-monitoring system includes a detecting unit that detects a remaining amount of liquid helium, in which a superconducting coil composing the magnetostatic field coil, is immersed, in a liquid helium container; a remaining amount estimating unit that calculates an estimated remaining amount on the basis of the remaining amount of liquid helium preliminarily detected by the detecting unit; and an output unit that outputs monitoring information on a superconducting magnet device on the basis of detected remaining amount and estimated remaining amount of liquid helium.
